(19) United States
(12) Patent Application Publication
(10) Pub. No.: US 2020/0056572 A1
(43) Pub. Date: Feb. 20, 2020

(54) ELECTROMAGNETICALLY ACTUATABLE INLET VALVE AND HIGH-PRESSURE PUMP COMPRISING AN INLET VALVE

(71) Applicant: Robert Bosch GmbH, Stuttgart (DE)

(72) Inventor: Tobias Landenberger, Schorndorf (DE)

(21) Appl. No.: 16/342,874

(22) PCT Filed: Oct. 17, 2017
(86) PCT No.: PCT/EP2017/076471

§ 371 Date: Apr. 17, 2019

(30) Foreign Application Priority Data
Oct. 18, 2016 (DE) 10 2016 220 364.9

(51) Int. Cl. F02M 59/02; F02M 59/36; F04B 53/10; F16K 27/02; F16K 31/06

(52) U.S. Cl. CPC F02M 59/025; F02M 59/368; F16K 31/0675; F16K 27/029; F16K 31/0655; F04B 53/10

(57) ABSTRACT

The invention relates to an electromagnetically actuatable inlet valve (24) for a high-pressure pump, in particular of a fuel-injection system. The inlet valve (24) has a valve member (34) which can be moved between an open position and a closed position. Provided is an electromagnetic actuator (60), by means of which the valve member (34) can be moved, wherein the electromagnetic actuator (60) has an armature (68) which acts at least indirectly on the valve member (34), a solenoid coil (64) which surrounds the armature (68), and a magnetic core (66), against which the armature (68) comes to rest, at least indirectly, when current is applied to the solenoid coil (64). The armature (68) is displaceably guided in a carrier element (78) and the carrier element (78) and the magnetic core (66) are interconnected and surrounded by a housing (69, 70, 71). The region of the connection (90) between the carrier element (78) and the magnetic core (68) is arranged in an inner chamber (91) of the housing (69, 70, 71). A seal (92, 94, 96) is provided between the magnetic housing (69) and the cylinder head (16) of the high pressure pump, said seal sealing the inner chamber (91) of the housing (69, 70, 71) with respect to the exterior of the housing (69, 70, 71).

### BACKGROUND OF THE INVENTION

The invention relates to an electromagnetically actuatable inlet valve for a high-pressure pump, in particularly of a fuel injection system. The invention further relates to a high-pressure pump having such an inlet valve.

An electromagnetically actuatable inlet valve for a high-pressure pump of a fuel injection system is disclosed by DE 10 2013 220 593 A1. The high-pressure pump comprises at least one pump element having a pump piston, which is driven in a reciprocating motion and which defines a pump working chamber. The pump working chamber can be connected to a fuel inlet via the inlet valve. The inlet valve comprises a valve member, which for control interacts with a valve seat and which is movable between an open position and a closed position. In its closed position the valve member comes to bear on the valve seat. The inlet valve further comprises an electromagnetic actuator, which serves to move the valve member. The electromagnetic actuator comprises an armature acting at least indirectly on the valve member, a solenoid coil surrounding the armature, and a magnetic core. The armature is displaceably guided in a carrier element, wherein the carrier element and the magnetic core are connected to one another. When the solenoid coil is energized, the armature is moveable in opposition to the force of a return spring and comes to bear at least indirectly on the magnetic core. When the armature strikes the magnetic core, this can impose large stresses on both of these components and on the connection between the carrier element and the magnetic core, which over a prolonged service life may lead to damaging of the connection between the magnetic core and the carrier element, which can adversely affect the ability of the inlet valve to function. The magnetic core may be connected to the carrier element by means of a sleeve, for example, which is welded to the two components. The magnetic core and the carrier element are enclosed by a housing, which may be of multipart design, and the connection between these components is arranged in an interior space of the housing. In operation, moisture can get into the interior space, which can result in corrosion to the connection of the magnetic core and the carrier element, thereby in particular reducing the load-bearing capacity of the welded connections. As a result, the connection between the magnetic core and the carrier element may become detached, so that the ability of inlet valve to function is no longer assured.

### SUMMARY OF THE INVENTION

The inlet valve according to the invention and the high-pressure pump according to the invention by contrast have the advantage that the seal between a magnet sleeve of the inlet valve and a cylinder head of the high-pressure pump prevents moisture getting into the interior space and therefore permanently ensures the ability of the inlet valve to function.

The fact that at least one elastically and/or plastically deformable contour, which bears on the opposing part of the cylinder head of the high-pressure pump, forming a seal, is arranged on the magnet sleeve advantageously allows additional sealing components to be dispensed with.

In all embodiments the contour is integrally formed on the magnet sleeve, advantageously obviating the need for any additional sealing elements.

Furthermore, the seal is formed by the contour of the magnet sleeve together with a sealing face of the cylinder head, so that existing components advantageously form the seal.

In one embodiment the contour of the magnet sleeve takes the form of a sharp edge, acting together with the sealing face of the cylinder head to produce an advantageous seal.

In a further embodiment the contour of the magnet sleeve takes the form of a projecting, elastically resilient collar, acting together with the sealing face of the cylinder head to produce an advantageous seal.

In a further embodiment the contour of the magnet sleeve is of spherical formation, acting together with the sealing face of the cylinder head to produce an advantageous seal.

The contour is furthermore designed as a self-contained ring enclosing the interior space, advantageously ensuring a seal over the entire circumference of the magnet sleeve.

The magnet sleeve is advantageously composed of a metallic material, affording an external seal against liquid media by means of a metallic sealing principle without any additional components.

In a development of the invention the magnet sleeve can be affixed to the cylinder head of the high-pressure pump by means of a fastening element, and in affixing the magnet sleeve by means of the fastening element a pretension is applied to the seal, thereby advantageously achieving a secure seal between the magnet sleeve and the sealing face of the cylinder head of the high-pressure pump.

### BRIEF DESCRIPTION OF THE DRAWINGS

Further advantages emerge from the drawing and the description.

Several exemplary embodiments of the invention are described in more detail below, referring to the drawing attached, in which:

FIG. 1: shows a schematic longitudinal section through a high-pressure pump;

FIG. 2: shows an enlarged representation of a detail denoted by I in FIG. 1 with an inlet valve of the high-pressure pump;

FIG. 3: shows an enlarged representation of a detail denoted by II in FIG. 2 according to a first exemplary embodiment of a seal and

FIGS. 4 to 6: show enlarged representations of embodiments of the detail denoted by III in FIG. 3.

### DETAILED DESCRIPTION

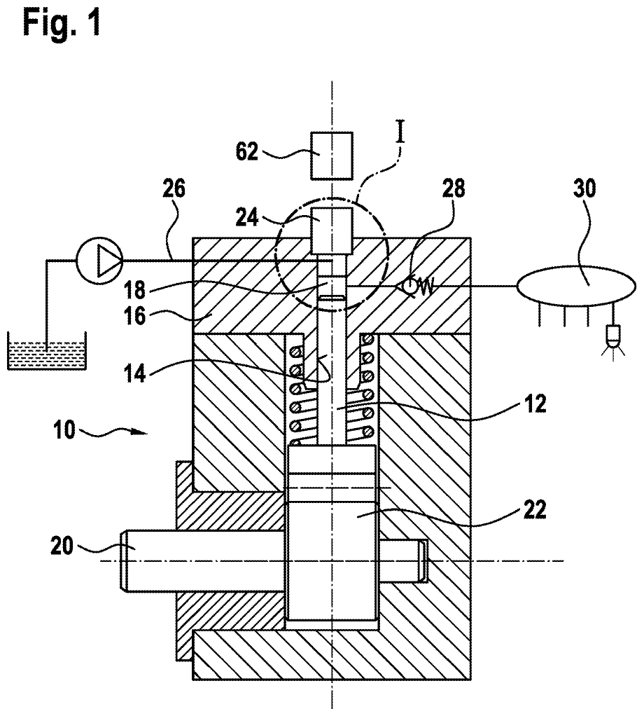

FIG. 1 represents a detail of a high-pressure pump which is intended for delivering fuel in a fuel injection system of an internal combustion engine. The high-pressure pump comprises at least one pump element 10, which in turn comprises a pump piston 12, which is driven in a reciprocating motion by a drive and guided in a cylinder bore 14 of a housing part 16 of the high-pressure pump, and which defines a pump working chamber 18 in the cylinder bore 14. The housing part 16 forms a cylinder head 16 of the high-pressure pump. As drive for the pump piston 12, a drive shaft 20 may be provided with a cam 22 or eccentric, on which the pump piston 12 is supported, either directly or by way of a tappet, for example a roller tappet. The pump working chamber 18 can be connected via an inlet valve 24 to a fuel inlet 26 and via an outlet valve 28 to a fuel accumulator. On the suction stroke of the pump piston 12, the pump working chamber 18 with the inlet valve 24 opened can be filled with fuel. On the delivery stroke of the pump piston 12, fuel is forced out of the pump working chamber 18 and delivered into the fuel accumulator 30.

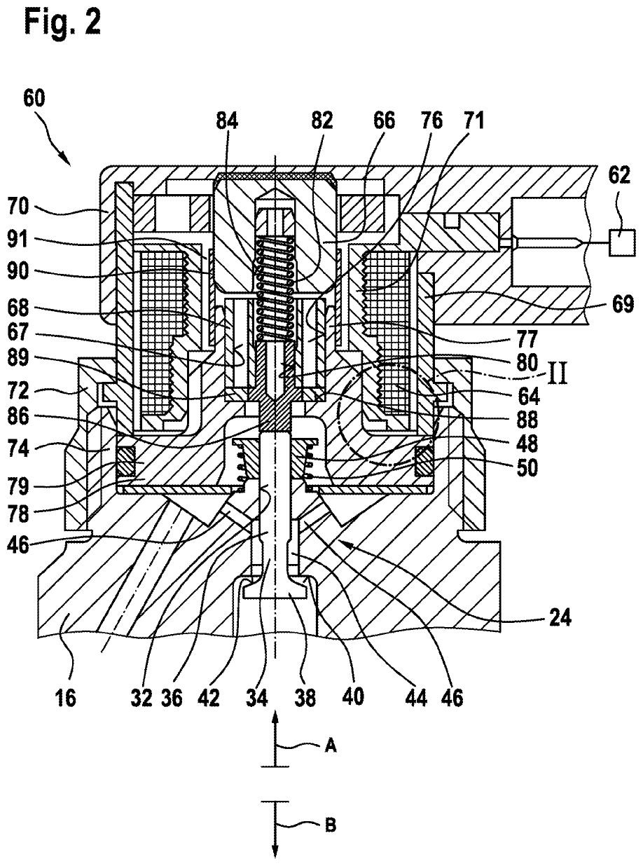

In the cylinder head 16 of the high-pressure pump, as shown in FIG. 2, a passage 32 of smaller diameter than the cylinder bore 14, which leads to the outside of the cylinder head 16, joins the cylinder bore 14 on its side remote from the pump piston 12. The inlet valve 24 comprises a piston-shaped valve member 34, which comprises a stem 36, displaceably guided in the passage 32 and a head 38, which is of larger diameter than the stem 36 and is arranged in the pump working chamber 18. At the transition from the cylinder bore 14 to the passage 32, a valve seat 40, with which the valve member 34 interacts by means of a sealing face 42 formed on its head 38, is formed on the cylinder head 16.

In a portion adjoining the valve seat 40 the passage 32 has a larger diameter than in its portion guiding the stem 36 of the valve member 34, so that an annular space 44 is formed surrounding the stem 36 of the valve member 34. Opening into the annular space 44 are one or more inlet bores 46, which on the other side leads to the outside of the cylinder head 16.

On the side of the cylinder head 16 remote from the pump working chamber 18, the stem 36 of the valve member 34 protrudes out of the passage 32 and affixed to this is a support element 48. Supported on the support element 48 is a valve spring 50, which is supported on the other side on an area of the cylinder head 16 surrounding the stem 36 of the valve member 34. In an actuating direction A, the valve spring 50 acts on the valve member 34 in its closing direction, the valve member 34 in its closed position bearing with its sealing face 42 against the valve seat 40. The valve spring takes the form, for example, of a helical compression spring.

The inlet valve 24 can be actuated by an electromagnetic actuator 60, which is represented, in particular, in FIG. 2. The actuator 60 is activated by an electronic control unit 62 as a function of operating parameters of the internal combustion engine to be supplied. The electromagnetic actuator 60 comprises a solenoid coil 64, a magnetic core 66 and an armature 68. The electromagnetic actuator 60 is arranged on the side of the inlet valve 24 remote from the pump working chamber 18. The magnetic core 66 and the solenoid coil 64 are arranged in a housing 70, which may be of multipart construction and which can be affixed to the cylinder head 16 of the high-pressure pump. The housing 70 may comprise a coil carrier 71, in which the solenoid coil 64 is accommodated, the coil carrier 71 being arranged inside the cup-shaped housing 70. The housing 70 may further comprise a magnet sleeve 69 enclosing the coil carrier 71. The housing can be affixed to the cylinder head 16, for example by means of a fastening element in the form of a threaded ring 72 gripping over this, which is screwed on a collar 74 of the cylinder head 16 provided with an external thread. The housing 70 and the coil carrier 71 are preferably made of plastic, the magnet sleeve 69 is preferably made of metal. The housing 70 can be produced by injection molding, for example, the coil carrier 71 and the magnet sleeve 69 being at least partially encapsulated by the plastic material of the housing 70.

The armature 68 is at least substantially of cylindrical formation and is displaceably guided by its outer casing in a bore 76 in a carrier element 78 arranged in the housing 70. The bore 76 in the carrier element 78 runs at least approximately coaxially with the passage 32 in the cylinder head 16 and hence coaxially with the valve member 34. The carrier element 78 has a cylindrical external shape in its end area 77 remote from the cylinder head 16. The magnetic core 66 is arranged in the housing 70 on the side of the carrier element 78 remote from the cylinder head 16 and has a cylindrical external shape.

The armature 68 has a central bore 80, which is arranged at least approximately coaxially with the longitudinal axis of the armature 68 and into which a return spring 82 projects, which is arranged on the side of the armature 68 remote from the valve member 34 and is supported on the armature 68. At its other end the return spring 82 is at least indirectly supported on the magnetic core 66, which has a central bore 84, into which the return spring 82 projects. A support element for the return spring 82 can be inserted, for example pressed, into the bore 84 of the armature 66. An intermediate element 86, which may take the form of an anchor bolt, is inserted into the central bore 80 of the armature 68. The anchor bolt 86 is preferably pressed into the bore 80 of the armature 68. In the bore 80 the return spring 80 may also be supported on the anchor bolt 86. The armature 68 may have one or more passages 67.

An annular shoulder 88, which serves to limit the movement of the armature 68 towards the inlet valve 24, is formed in the bore 76 by a reduction in diameter between the armature 68 and the inlet valve 24. If the housing 70 is not yet fixed to the cylinder head 16 of the high-pressure pump, the annular shoulder 88 secures the armature 68 and prevents it from falling out of the bore 76. A washer 89 may be arranged between the annular shoulder 88 and the armature 68.

The carrier element 78 and the magnetic core 66 are connected to one another by means of a sleeve-shaped connecting element 90. The connecting element 90 here is arranged with its one axial end area on the cylindrical portion 77 of the carrier element 78 and connected to the latter, and with its other axial end area is arranged on the cylindrical magnetic core 66 and connected to this. The connecting element 90 is connected to the carrier element 78 and the magnetic core 66 by a cohesive material joint, for example, in particular welded thereto. The connecting element 90 is arranged in an interior space 91 of the housing 70 situated inside the coil carrier 71. When the solenoid coil 64 is energized, the armature 68 is drawn towards the magnetic core 66 in opposition to the force of the return spring 82 and comes to bear at least indirectly on the magnetic core 66.

Together with the carrier element 78 the magnetic core 66 forms a pre-assembled unit, which after manufacture of the housing 70 is inserted into the interior space 91. In its end area remote from the cylinder head 16 of the high-pressure pump the carrier element 78 has a flange-shaped portion 79 of larger diameter than the cylindrical portion 77. The flange-shaped portion 79 rests on the outside of the cylinder head 16 of the high-pressure pump, and on the side of the flange-shaped portion 79 remote from the cylinder head 16 the housing 70 and/or the coil carrier 71 bears on this. It is proposed according to the invention that a seal 92, 94, 96 be provided between the magnet sleeve 69 and the cylinder head 16 which serves to seal the interior space 91 of the housing 69, 70, 71 off from the outside of the housing 69, 70, 71, so that moisture cannot get into the latter.

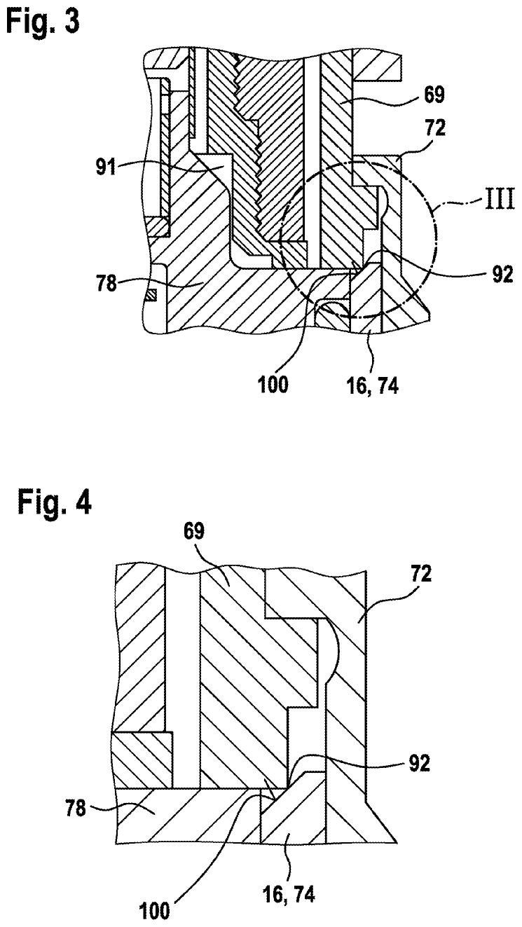

In a first exemplary embodiment represented in FIG. 3 a seal 92 is provided for sealing between the cylinder head 16 and the magnet sleeve 69.

An elastically and/or plastically deformable contour 92, which bears on the opposing part of the cylinder head 16 of the high-pressure pump to form a seal, is arranged on the magnet sleeve 69, the contour 92 being integrally formed on the magnetic sleeve 69. The magnet sleeve 68 and therefore also the contour 92 are composed of a metallic material.

The contour 92 of the magnet sleeve 69 together with a sealing face 100 on the collar 74 of the cylinder head 16 forms the seal 92, the contour 92 taking the form of a self-contained ring enclosing the interior space 91.

In affixing the magnet sleeve 69 to the cylinder head 16 of the high-pressure pump by means of the threaded ring 72, a pretension is applied to the seal 92, the contour 92 being elastically and/or plastically compressed and a secure sealing of the interior space 91 therefore being achieved.

In the assembly process a contact face is likewise produced between the magnet sleeve 69 and the carrier element 78, which provides for an assured magnetic flux of the inlet valve 24.

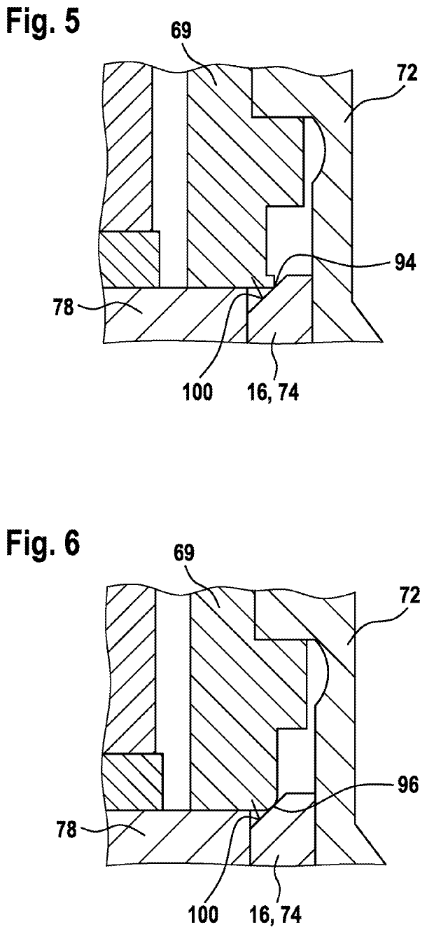

FIG. 4 represents a first exemplary embodiment of the seal according to FIG. 3, illustrating the contour 92 of the seal between the magnet sleeve 69 and the sealing face 100 on the collar 74 of the cylinder head 16. The contour 92 takes the form of a sharp edge, this edge together with the sealing face 100 forming the seal 92 after the required pre-tensioning.

FIG. 5 represents a second exemplary embodiment of the seal according to FIG. 3, in which the contour 94 of the seal between the magnet sleeve 69 and the sealing face 100 on the collar 74 of the cylinder head 16 takes the form of a projecting, elastically resilient collar. Here, after the required pre-tensioning, this contour together with the sealing face 100 forms the seal 94, the elastically resilient collar yielding elastically and/or plastically.

FIG. 6 represents a third exemplary embodiment of the seal according to FIG. 3, in which the contour 96 of the seal between the magnet sleeve 69 and the sealing face 100 on the collar 74 of the cylinder head 16 is of spherical formation. Here, after the required pre-tensioning, this contour together with the sealing face 100 forms the seal 96.

1. An electromagnetically actuatable inlet valve (24) for a high-pressure pump, the inlet valve (24) comprising a valve member (34), which is movable between an open position and a closed position, and comprising an electromagnetic actuator (60) configured to move the valve member (34), wherein the electromagnetic actuator (60) comprises an armature (68) acting at least indirectly on the valve member (34), a solenoid coil (64) surrounding the armature (68), and a magnetic core (66), on which the armature (68) comes to bear at least indirectly when the solenoid coil (64) is energized, wherein the armature (68) is displaceably guided in a carrier element (78), wherein the carrier element (78) and the magnetic core (66) are connected to one another and are enclosed by a housing (69, 70, 71) and an area of connection between the carrier element (78) and the magnetic core (68) is arranged in an interior space (91) of the housing (69, 70, 71), characterized in that a seal (92, 94, 96), which seals off the interior space (91) of the housing (69, 70, 71) from an outside of the housing (69, 70, 71), is provided between a magnet sleeve (69) and a cylinder head (16) of the high-pressure pump.

2. The inlet valve as claimed in claim 1, characterized in that at least one elastically and/or plastically deformable contour (92, 94, 96), which bears on an opposing part of the cylinder head (16) of the high-pressure pump, forming the seal, is arranged on the magnet sleeve (69).

3. The inlet valve as claimed in claim 2, characterized in that the contour (92, 94, 96) is integrally formed on the magnet sleeve (69).

4. The inlet valve as claimed in claim 3, characterized in that the contour (92, 94, 96) of the magnet sleeve (69) together with a sealing face (100) of the cylinder head (16) forms the seal (92, 94, 96).

5. The inlet valve as claimed in claim 2, characterized in that the contour (92, 94) takes the form of a sharp edge.

6. The inlet valve as claimed in claim 2, characterized in that the contour (94) takes the form of an elastically resilient collar.

7. The inlet valve as claimed in claim 2, characterized in that the contour (96) is of spherical formation.

8. The inlet valve as claimed in claim 2, characterized in that the contour (92, 94, 96) takes the form of a self-contained ring enclosing the interior space (91).

9. The inlet valve as claimed in claim 1, characterized in that the magnet sleeve (69) is composed of a metallic material.

10. The inlet valve as claimed in claim 1, characterized in that the magnet sleeve (69) is configured to be affixed to the cylinder head (16) of the high-pressure pump by a fastening element (72) such that a pretension is applied to the seal (92, 94, 96).

11. A high-pressure pump, in particular a high pressure fuel pump, comprising a cylinder head (16) and at least one pump element (10), which comprises a pump piston (12) defining a pump working chamber (18), wherein the pump working chamber (18) is connected via an inlet valve (24) to an inlet (26), characterized in that the inlet valve (24) comprises:
a valve member (34), which is movable between an open position and a closed position, and an electromagnetic actuator (60) configured to move the valve member (34), wherein the electromagnetic actuator (60) comprises an armature (68) acting at least indirectly on the valve member (34), a solenoid coil (64) surrounding the armature (68), and a magnetic core (66), on which the armature (68) comes to bear at least indirectly when the solenoid coil (64) is energized, wherein the armature (68) is displaceably guided in a carrier element (78), wherein the carrier element (78) and the magnetic core (66) are connected to one another and are enclosed by a housing (69, 70, 71) and an area of connection between the carrier element (78) and the magnetic core (68) is arranged in an interior space (91) of the housing (69, 70, 71), wherein a seal (92, 94, 96), which seals off the interior space (91) of the housing (69, 70, 71) from an outside of the housing (69, 70, 71), is provided between a magnet sleeve (69) and the cylinder head (16).

12. The high-pressure pump as claimed in claim 11, characterized in that at least one elastically and/or plastically deformable contour (92, 94, 96), which bears on an opposing part of the cylinder head (16) of the high-pressure pump, forming the seal, is arranged on the magnet sleeve (69).

13. The high-pressure pump as claimed in claim 12, characterized in that the contour (92, 94, 96) is integrally formed on the magnet sleeve (69).

14. The high-pressure pump as claimed in claim 13, characterized in that the contour (92, 94, 96) of the magnet sleeve (69) together with a sealing face (100) of the cylinder head (16) forms the seal (92, 94, 96).

15. The high-pressure pump as claimed in claim 12, characterized in that the contour (92, 94) takes the form of a sharp edge.

16. The high-pressure pump as claimed in claim 12, characterized in that the contour (94) takes the form of an elastically resilient collar.

17. The high-pressure pump as claimed in claim 12, characterized in that the contour (96) is of spherical formation.

18. The high-pressure pump as claimed in claim 12, characterized in that the contour (92, 94, 96) takes the form of a self-contained ring enclosing the interior space (91).

19. The high-pressure pump as claimed in claim 11, characterized in that the magnet sleeve (69) is composed of a metallic material.

20. The high-pressure pump as claimed in claim 11, characterized in that the magnet sleeve (69) is configured to be affixed to the cylinder head (16) of the high-pressure pump by a fastening element (72) such that a pretension is applied to the seal (92, 94, 96).
